(19) United States
(12) Patent Application Publication
(10) Pub. No.: US 2019/0275678 A1
(43) Pub. Date: Sep. 12, 2019

(54) ROBOT CONTROL DEVICE, ROBOT, ROBOT SYSTEM, AND ROBOT CONTROL METHOD

(71) Applicant: Seiko Epson Corporation, Tokyo (JP)

(72) Inventor: Kaoru TAKEUCHI, Azumino (JP)

(21) Appl. No.: 16/348,891

(22) PCT Filed: Oct. 24, 2017
(86) PCT No.: PCT/JP2017/038364

§ 371 Date: May 10, 2019

(30) Foreign Application Priority Data
Nov. 11, 2016 (JP) 2016-220245
Sep. 29, 2017 (JP) 2017-189820

(51) Int. Cl. B25J 9/16; B25J 13/08

(52) U.S. Cl. CPC B25J 9/1694; B25J 9/163; B25J 13/085

(57) ABSTRACT

A robot control device is configured to perform, during movement of an end effector of a robot in a movement direction of a target object, force control by which a force acts on the target object based on an output of a force detection unit included in the robot to cause the robot to perform work on the target object by the end effector. Whether the work is able to be started is determined in a process where the end effector follows the movement of the target object, and when it is determined that the work is able to be started, the work is caused to start.

### BACKGROUND

### 1. Technical Field

The present invention relates to a robot control device, a robot, a robot system, and a robot control method.

### 2. Related Art

In the related art, there are known technologies for picking up target objects (workpieces) transported by transport devices with robots. For example, JP-A-2015-174171 discloses a technology for suppressing an influence of flexure, extrusion, and slant of a conveyer by defining two coordinate systems in a region on a transport device, selecting one of the coordinate systems according to the position of a target object, and outputting an operation instruction to a robot using the selected coordinate system.

In the above-described technology of the related art, work cannot be performed on moving target objects, such as a target object which is being transported by a transport device or a target object gripped and moved by a robot, with a robot. That is, it was difficult to perform various kinds of work such as screw fastening or grinding on moving target objects.

### SUMMARY

In order to solve at least one of the problems described above, a robot control device of the present invention performs, during movement of an end effector of a robot in a movement direction of a target object, force control by which a force acts on the target object based on an output of a force detection unit included in the robot to cause the robot to perform work on the target object by the end effector.

That is, during the movement of the end effector in the movement direction of the target object, the force control by which the force acts on the target object is performed to cause the robot to perform work on the target object by the end effector. For that reason, it is possible to perform the work by the force in a situation in which the end effector is moved in the movement direction of the target object in association with the movement of the target object. According to the configuration described above, it is possible to perform the work by the force control even when the target object is being moved.

In the robot control device, a configuration in which whether the work is able to be started is determined in a process where the end effector follows the movement of the target object, and when it is determined that the work is able to be started, the work is caused to start may be adopted. According to this configuration, the work is not started before preparation is completed, and it is possible to reduce a possibility that failure of the work occurs.

The robot control device may be configured such that, when the robot is caused to perform the work, a control target position is obtained by adding a first position correction amount representing a movement amount of the target object and a second position correction amount calculated by the force control to a target position when assuming that the target object is stopped and feedback control using the control target position is executed. According to this configuration, it is possible to easily perform feedback control when performing work with force control while following the movement of the target object.

The robot control device may be configured such that a representative correction amount determined from a history of the second position correction amount is acquired and the representative correction amount is added to the first position correction amount relating to a new target object when the end effector is caused to follow the new target object. According to this configuration, control on the new target object becomes simple control.

The robot control device may be configured to include a position control unit that obtains the target position and the first position correction amount, a force control unit that obtains the second position correction amount, and an instruction integration unit that obtains the control target position by adding the first position correction amount and the second position correction amount to the target position and executes feedback control using the control target position. According to this configuration, it is possible to easily perform the feedback control when performing work with force control while following the movement of the target object.

Alternatively, the robot control device may be configured to further include a processor configured to execute a computer executable instruction to control the robot, and the processor may be configured to obtain the target position, the first position correction amount, and the second position correction amount, obtain the control target position by adding the first position correction amount and the second position correction amount to the target position, and execute feedback control using the control target position. Even with this configuration, it is possible to easily perform the feedback control when performing work with force control while following the movement of the target object.

The robot control device may be configured such that the end effector follows the target object and is caused to move in a direction parallel to the movement direction of the target object and in order for the robot to perform the force control, the end effector is caused to move in a direction perpendicular to the movement direction of the target object. According to this configuration, it is possible to perform the work accompanying movement in a direction perpendicular to the movement direction of the target object.

The robot control device may be configured such that a screw driver included in the end effector is caused to perform work of screw fastening on the target object. According to this configuration, it is possible to perform the work of screw fastening on the moving target object by the robot.

The robot control device may be configured such that work of fitting a fitting object gripped by a gripping unit included in the end effector into a fitting portion formed on the target object is caused to be performed. According to this configuration, it is possible to perform the fitting work on the moving target object by the robot.

The robot control device may be configured such that a grinding tool included in the end effector is caused to perform work of grinding the target object. According to this configuration, it is possible to perform the grinding work on the moving target object by the robot.

The robot control device may be configured such that a deburring tool included in the end effector is caused to perform work of deburring the target object. According to this configuration, it is possible to perform the deburring work on the moving target object by the robot.

### BRIEF DESCRIPTION OF THE DRAWINGS

FIG. 1 is a perspective view illustrating a robot system.

FIG. 2 is a conceptual diagram illustrating an example of a control device including a plurality of processors.

FIG. 3 is a conceptual diagram illustrating another example of the control device including the plurality of processors.

FIG. 4 is a functional block diagram illustrating a robot control device.

FIG. 5 is a diagram illustrating a GUI.

FIG. 6 is a diagram illustrating examples of commands.

FIG. 7 is a flowchart illustrating a screw fastening process.

FIG. 8 is a diagram schematically illustrating a relation between a screw hole H and TCP.

FIG. 9 is a functional block diagram illustrating a robot control device.

FIG. 10 is a perspective view illustrating a robot system.

FIG. 11 is a perspective view illustrating a robot system.

FIG. 12 is a perspective view illustrating a robot system.

FIG. 13 is a flowchart illustrating a fitting process.

FIG. 14 is a perspective view illustrating a robot system.

FIG. 15 is a flowchart of a grinding process.

FIG. 16 is a perspective view illustrating a robot system.

FIG. 17 is a flowchart illustrating a deburring process.

### DESCRIPTION OF EXEMPLARY EMBODIMENTS

Hereinafter, embodiments of the present invention will be described in the following order with reference to the appended drawings. The same reference numerals are given to corresponding constituent elements in the drawings and the repeated description thereof will be omitted.

(1) Configuration of Robot System

(2) Screw Fastening Process

(3) Other Embodiments

### (1) Configuration of Robot System

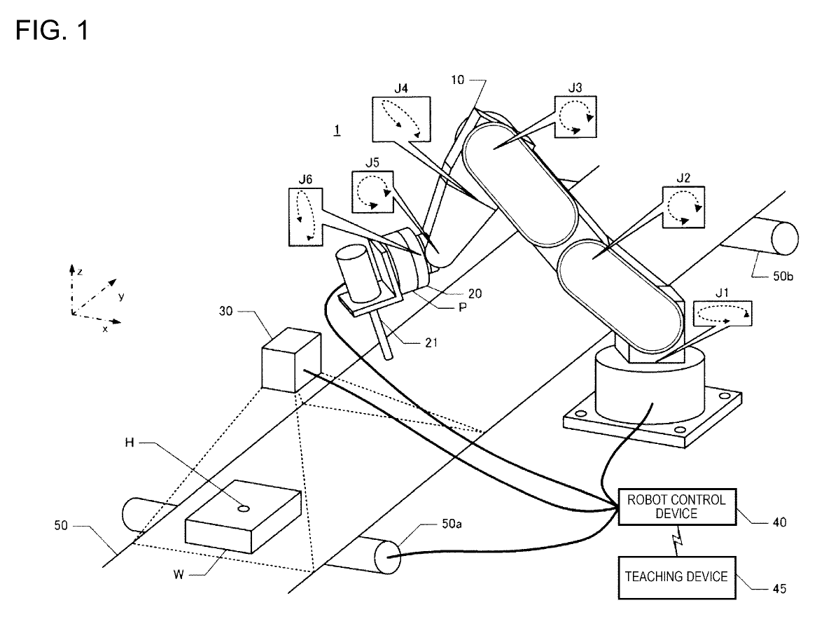

FIG. 1 is a perspective view illustrating a robot controlled by a robot control device and a transport path of a target object (workpiece) according to an embodiment of the present invention. A robot system according to an example of the present invention includes a robot 1, an end effector 20, a robot control device 40, and a teaching device 45 (teaching pendant), as illustrated in FIG. 1. The robot control device 40 is connected to be able to communicate with the robot 1 by a cable. Constituent elements of the robot control device 40 may be included in the robot 1. The robot control device 40 and the teaching device 45 are connected by a cable or to be able to be wirelessly communicated. The teaching device 45 may be a dedicated computer or may be a general computer on which a program for teaching the robot 1 is installed. Further, the robot control device 40 and the teaching device 45 may include separate casings, as illustrated in FIG. 1 or may be configured to be integrated.

As a configuration of the robot control device 40, various configurations other than the configuration illustrated in FIG. 1 can be adopted. For example, the processor and the main memory may be deleted from the control device 40 of FIG. 1, and a processor and a main memory may be provided in another device communicably connected to the control device 40. In this case, the entire apparatus including the other device and the control device 40 functions as the control device of the robot 1. In another embodiment, the control device 40 may have two or more processors. In yet another embodiment, the control device 40 may be realized by a plurality of devices communicably connected to each other. In these various embodiments, the control device 40 is configured as a device or group of devices including one or more processors configured to execute computer-executable instructions to control the robot 1.

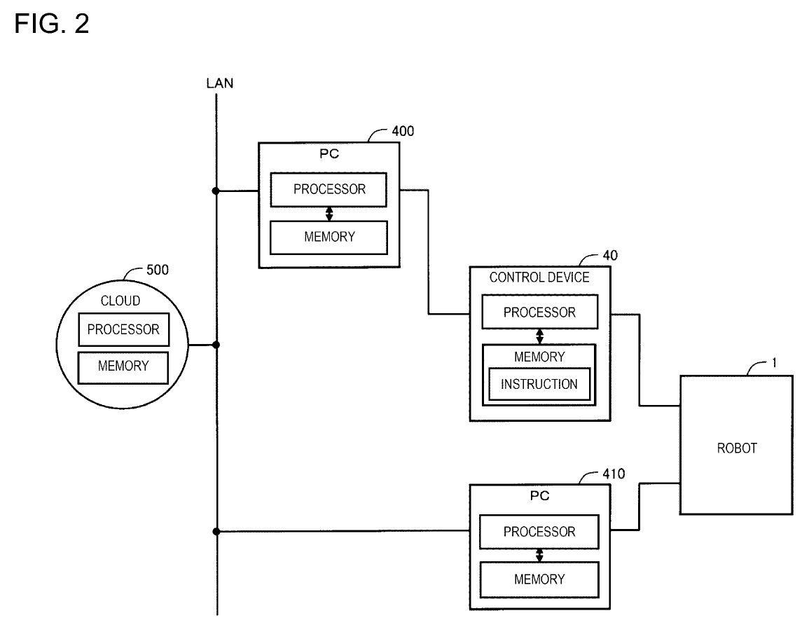

FIG. 2 is a conceptual diagram illustrating an example in which a robot control device is configured by a plurality of processors. In this example, in addition to the robot 1 and its control device 40, personal computers 400 and 410 and a cloud service 500 provided through a network environment such as a LAN are depicted. Each of the personal computers 400 and 410 includes a processor and a memory. In the cloud service 500, a processor and a memory can also be used. It is possible to realize the control device of the robot 1 by using some or all of the plurality of processors.

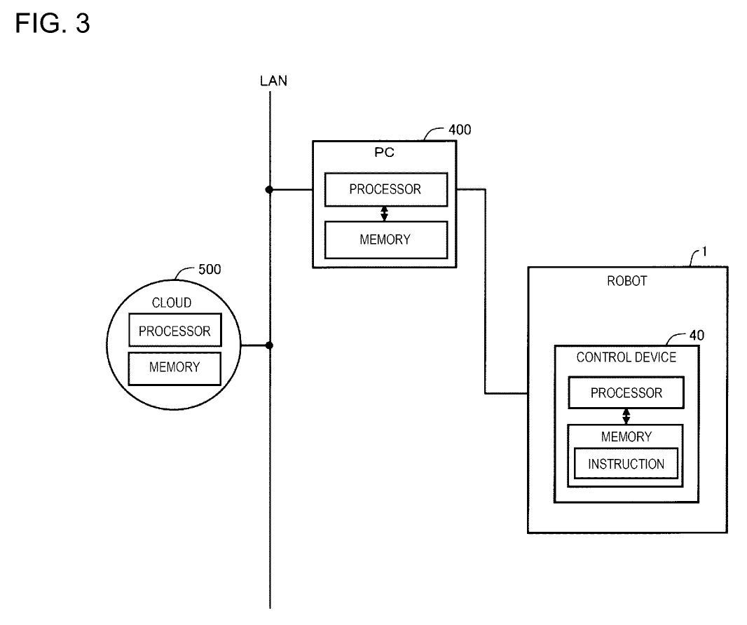

FIG. 3 is a conceptual diagram illustrating another example in which the robot control device is configured by a plurality of processors. This example is different from FIG. 2 in that the control device 40 of the robot 1 is stored in the robot 1. Also in this example, it is possible to realize the control device of the robot 1 by using some or all of the plurality of processors.

The robot 1 of FIG. 1 is a single arm robot in which any of various end effectors 20 is mounted on an arm 10 for use. The arm 10 includes six joints J1 to J6. The joints J2, J3, and J5 are flexure joints and the joints J1, J4, and J6 are torsional joints. Any of the various end effectors 20 that performs gripping, processing, or the like on the target object (workpiece) is mounted on the joint J6. A predetermined position of a tip end of the arm 10 is indicated as a tool center point (TCP). The TCP is a position used as a reference of the position of the end effector 20 and can be arbitrarily set. For example, the position on the rotational axis of the joint J6 can be set as the TCP. Further, when a screw driver is used as the end effector 20, a tip end of the screw driver can be set as the TCP. In the example, a 6-axis robot is exemplified. However, any joint mechanism may be used as long as a robot can move in a direction in which force control is performed and a transport direction of a transport device.

The robot 1 can dispose the end effector 20 at any position within a movable range to be in any attitude (angle) by driving the 6-axis arm 10. The end effector 20 includes a force sensor P and a screw driver 21. The force sensor P is a sensor that measures forces of three axes acting on the end effector 20 and torques acting around the three axes. The force sensor P detects the magnitudes of forces parallel to three detection axes perpendicular to each other in a sensor coordinate system which is an inherent coordinate system and the magnitudes of the torques around the three detection axes. Force sensors may be included as one or more force detectors of the joints J1 to J5 other than the joint J6. A force detection unit as a detection unit of a force may be able to detect a force or torque in a direction to be controlled and a unit such as a force sensor directly detecting a force or torque or a unit detecting a torque of a joint of a robot and indirectly obtaining the torque may be used. A force or torque in only a direction in which the force is controlled may be detected.

When a coordinate system defining a space in which the robot 1 is installed is a robot coordinate system, the robot coordinate system is a 3-dimensional orthogonal coordinate system defined by the x and y axes perpendicular to each other on a horizontal plane and the z axis of which a vertical rise is a positive direction (see FIG. 1). The negative direction of the z axis is substantially identical to the gravity direction. Rx represents a rotation angle around the x axis, Ry represents a rotation angle around the y axis, and Rz represents a rotation angle around the z axis. Any position in a 3-dimensional space can be expressed by positions in x, y, and z directions and any attitude in the 3-dimensional space can be expressed by rotation angles in Rx, Ry, and Rz directions. Hereinafter, when a position is notated, the position is assumed to also mean an attitude. In addition, when a force is notated, the force is assumed to also mean torque. The robot control device 40 controls the position of the TCP in the robot coordinate system by driving the arm 10.

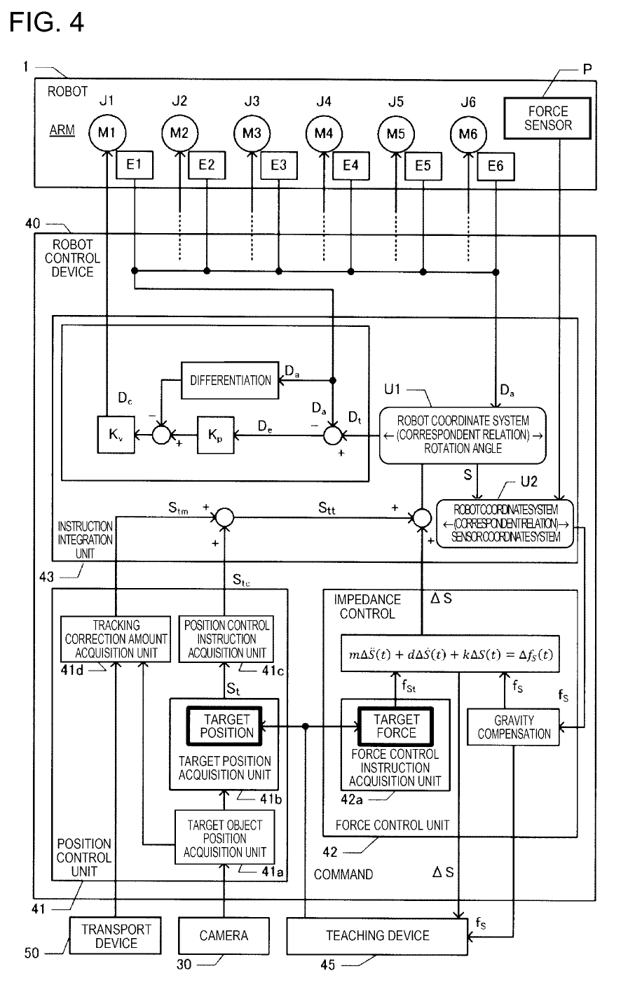

As illustrated in FIG. 4, the robot 1 is a general robot capable of performing various kinds of work by performing teaching, and includes motors M1 to M6 as actuators and includes encoders E1 to E6 as position sensors. Controlling the arm 10 means controlling the motors M1 to M6. The motors M1 to M6 and the encoders E1 to E6 are included to correspond to the joints J1 to J6, respectively, and the encoders E1 to E6 detect rotation angles of the motors M1 to M6.

The robot control device 40 stores a correspondent relation U1 between combinations of the rotation angles of the motors M1 to M6 and the position of the TCP in the robot coordinate system. The robot control device 40 stores at least one of a target position Sₜ and a target force f_{St} based on a command for each work process performed by the robot 1. The command is described with a known control language. A command in which the target position Sₜ of the TCP and the target force f_{St} of the TCP are arguments (parameters) is set for each work process performed by the robot 1.

Here, the letter S is assumed to represent one direction among directions (x, y, z, Rx, Ry, and Rz) of the axes defining the robot coordinate system. In addition, S is assumed to also represent a position in an S direction. For example, when S=x, an x direction component at a target position set in the robot coordinate system is represented as Sₜ=xₜ and an x direction component of the target force is represented as f_{St}=fₓₜ. The target force is a force which acts on the TCP and a force to be detected by the force sensor P when the force acts on the TCP can be specified using a correspondent relation of the coordinate system or a positional relation between the TCP and the force sensor P. In the embodiment, the target position Stand the target force f_{St} are defined with the robot coordinate system.

The robot control device 40 acquires rotation angles Dₐ of the motors M1 to M6 and converts the rotation angles Dₐ into the positions S (x, y, z, Rx, Ry, and Rz) of the TCP in the robot coordinate system based on the correspondent relation U1. The robot control device 40 converts a force actually acting on the force sensor P into an acting force f_{S} acting on the TCP based on a position S of the TCP and a detected value and a position of the force sensor P and specifies the acting force f_{S} in the robot coordinate system.

Specifically, a force acting on the force sensor P is defined in a sensor coordinate system in which a point different from the TCP is set as the origin. The robot control device 40 stores a correspondent relation U2 in which a direction of a detection axis in the sensor coordinate system of the force sensor P is defined for each position S of the TCP in the robot coordinate system. Accordingly, the robot control device 40 can specify the acting force f_{S} acting on the TCP in the robot coordinate system based on the position S of the TCP in the robot coordinate system, the correspondent relation U2, and the detected value of the force sensor P. Torque acting on the robot can be calculated from the acting force f_{S} and a distance from a tool contact point (a contact point of the end effector 20 and the target object W) to the force sensor P and is specified as an f_{S} torque component (not illustrated).

In this embodiment, a case in which teaching is given to perform screw fastening work to insert a screw into a screw hole H formed in a target object W with a screw driver 21 and the screw fastening work is performed will be described as an example.

In the embodiment, the target object W is transported by a transport device 50. That is, the transport device 50 has a transport plane parallel to the x-y plane defined by the xyz coordinate system illustrated in FIG. 1. The transport device 50 includes transport rollers 50a and 50b and can move the transport plane in the y axis direction by rotating the transport rollers 50a and 50b. Accordingly, the transport device 50 can transport the target object W mounted on the transport plane in the y axis direction. The xyz coordinate system illustrated in FIG. 1 is fixedly defined in advance with respect to the robot 1. Accordingly, in the xyz coordinate system, a position of the target object W and a position (a position of the arm 10 or the screw driver 21) of the robot 1 or an attitude of the robot 1 can be defined.

A sensor (not illustrated) is mounted on the transport roller 50a of the transport device 50 and the sensor outputs a signal according to a rotation amount of the transport roller 50a. In the transport device 50, the transport plane is moved without being slipped with rotation of the transport rollers 50a and 50b, and thus, an output of the sensor indicates a transport amount (a movement amount of the transported target object W) by the transport device 50.

On the upper side (the z axis positive direction) of the transport device 50, a camera 30 is supported by a support unit (not illustrated). The camera 30 is supported by the support unit so that a range indicated by a dotted line in the z axis negative direction is included in a field of view. In this embodiment, the position of an image captured by the camera 30 is associated with a position of the transport device 50 on the transport plane. Accordingly, when the target object W is within the field of view of the camera 30, x-y coordinates of the target object W can be specified based on the position of an image of the target object W in an output image of the camera 30.

The robot control device 40 is connected to the robot 1 and driving of the arm 10, the screw driver 21, the transport device 50, and the camera 30 can be controlled under the control of the robot control device 40. The robot control device 40 is realized by causing a computer including a CPU, a RAM, a ROM, and the like to execute a robot control program. A type of the computer may be any type of computer. For example, the computer can be configured by a portable computer or the like.

The transport device 50 is connected to the robot control device 40, and the robot control device 40 can output control signals to the transport rollers 50a and 50b and control start and end of driving of the transport rollers 50a and 50b. The robot control device 40 can acquire a movement amount of the target object W transported by the transport device 50 based on an output of the sensor included in the transport device 50.

The camera 30 is connected to the robot control device 40. When the target object W is imaged by the camera 30, the captured image is output to the robot control device 40. The screw driver 21 can insert a screw adsorbed onto a bit into a screw hole by rotating the screw. The robot control device 40 can output a control signal to the screw driver 21 and perform the adsorption of the screw and the rotation of the screw.

Further, the robot control device 40 can move the arm 10 included in the robot 1 to any position within the movable range by outputting control signals to the motors M1 to M6 included in the robot 1 (FIG. 4) and set any attitude within the movable range. Accordingly, the end effector 20 can be moved to any position within the movable range and any attitude can be set, and thus the tip end of the screw driver 21 can be moved to any position within the movable range and any attitude can be set within the movable range. Accordingly, the robot control device 40 can move the tip end of the screw driver 21 to a screw supply device (not illustrated) and pick up the screw by adsorbing the screw onto the bit. Further, the robot control device 40 moves the end effector 20 by controlling the robot 1 such that the screw is located above the screw hole of the target object W. Then, the robot control device 40 performs the screw fastening work by approaching the tip end of the screw driver 21 to the screw hole and rotating the screw adsorbed onto the bit.

In this embodiment, the robot control device 40 can perform force control and position control to perform such work. The force control is control in which a force acting on the robot 1 (including a region such as the end effector 20 interlocked with the robot 1) is set as a desired force and is control in which a force acting on the TCP is set as a target force in this embodiment. That is, the robot control device 40 can specify the force acting on the TCP interlocked with the robot 1 based on a current force detected by the force sensor P. Thus, based on a detected value of the force sensor P, the robot control device 40 can control each joint of the arm 10 such that the force acting on the TCP becomes the target force.

A control amount of the arm may be determined in accordance with any of various schemes. For example, a configuration in which the control amount can be determined through impedance control can be adopted. In any case, when the acting force on the TCP specified based on a force detected by the force sensor P is not the target force, the robot control device 40 moves the end effector 20 by controlling each joint of the arm 10 such that the force acting on the TCP is close to the target force. By repeating this process, the control is performed such that the force acting on the TCP is the target force. Of course, the robot control device 40 may control the arm 10 such that torque output from the force sensor P becomes target torque.

The position control is control in which the robot 1 (including a region such as the end effector 20 interlocked with the robot 1) is moved to a scheduled position. That is, a target position and a target attitude of a specific region interlocked with the robot 1 are specified by teaching, trajectory calculation, or the like, and the robot control device 40 moves the end effector 20 by controlling each joint of the arm 10 such that the target position and the target attitude are set. Of course, in the control, a control amount of a motor may be acquired by feedback control such as proportional-integral-derivative (PID) control.

As described above, the robot control device 40 drives the robot 1 under the force control and the position control. However, in the embodiment, since the target object W which is a work target is moved by the transport device 50, the robot control device 40 has a configuration to perform work on the target object W which is being moved.

FIG. 4 is a block diagram illustrating an example of the configuration of the robot control device 40 performing the work on the target object W which is being moved. When the robot control program is executed on the robot control device 40, the robot control device 40 functions as a position control unit 41, a force control unit 42, and an instruction integration unit 43. The position control unit 41, the force control unit 42, and the instruction integration unit 43 may be configured as a hardware circuit.

The position control unit 41 has a function of controlling the position of the end effector 20 of the robot 1 according to a target position designated by a command created in advance. The position control unit 41 also has a function of moving the end effector 20 of the robot 1 to follow the moving target object W. The position of the moving target object W may be acquired in accordance with any of various schemes. However, in this embodiment, a position (x-y coordinates) of the target object W at an imaging time is acquired based on an image captured by the camera 30, a movement amount of the target object W is acquired based on the sensor included in the transport device 50, and a position of the target object W at any time is specified based on the movement amount of the target object W after a time at which the target object W is imaged.

In order to specify the position of the target object W and follow the target object W, in this embodiment, the position control unit 41 further executes functions of a target object position acquisition unit 41a, a target position acquisition unit 41b, a position control instruction acquisition unit 41c, and a tracking correction amount acquisition unit 41d. The target object position acquisition unit 41a has a function of acquiring the position (x-y coordinates) of the target object W (specifically, a screw hole on the target object W) within the field of view based on an image output from the camera 30.

The target position acquisition unit 41b has a function of acquiring the position of TCP when the screw driver 21 is in a desired position (including attitude) as the target position Sₜ in the screw fastening work. The target position Sₜ is designated by a command prepared by teaching using the teaching device 45. In this embodiment, for example, a position offset by a predetermined amount from the screw hole in the z axis positive direction is taught as a target position immediately before the work is started, and a position advanced in the z axis negative direction by the screw fastening amount (the screw advancing distance by screw fastening) is taught as the target position after the start of work. In this embodiment, the target position designated by this teaching is not a position in the robot coordinate system but a relative position with respect to the target object W as a reference. However, it is also possible to teach the target position as the position in the robot coordinate system. When teaching is performed, a command indicating the teaching contents is generated and stored in the robot control device 40.

For example, the target position of the TCP before the work of inserting the screw into the screw hole of the target object W is a position at which the TCP is to be disposed in order to dispose the tip end of the screw above the screw hole by a given distance (for example, 5 mm). The command indicates that the position above the screw hole of the target object W by the given distance is the position of the tip end of the screw. In this case, the target position acquisition unit 41b acquires the position (x-y coordinates) of the screw hole acquired by the target object position acquisition unit 41a and acquires the position of the TCP for which the screw is disposed at a position at which an offset equivalent to the above-described given distance and the height of the target object W is provided upward from the origin of the z axis as the target position Sₜ. The target position Sₜ of this TCP is the position expressed in the robot coordinate system.

The position control instruction acquisition unit 41c acquires a control instruction to move the TCP to the target position Sₜ acquired by the target position acquisition unit 41b. In this embodiment, by repeating the position control (and the force control to be described) for each infinitesimal time, the TCP is moved to the target position Sₜ.

When the TCP is moved to the target position before starting work, the position control instruction acquisition unit 41c divides a time interval from an imaging time of the target object W by the camera 30 to a movement completion time in which movement to the target position is completed for each infinitesimal time. Then, the position control instruction acquisition unit 41c specifies the position of the TCP as a target position Stc at each infinitesimal time at each time at which the position of the TCP at the imaging time of the target object W by the camera 30 is moved to the target position Sₜ for a period until the movement completion time. As a result, when the infinitesimal time is ΔT, an imaging time is T, the movement completion time to the target position Sₜ is Tf, the target position S_{tc} of the TCP at each time of T, T+ΔT, T+2ΔT, Tf−ΔT, Tf is specified. The position control instruction acquisition unit 41c sequentially outputs the target position S_{tc} at a subsequent time at each time. For example, the target position S_{tc} at time T+ΔT is output at the imaging time T and the target position S_{tc} at time T+2ΔT is output at time T+ΔT.

The target position S_{tc} for each infinitesimal time output here is a position instruction assumed when the target object W is stopped. That is, the target object position acquisition unit 41a acquires the position of a target object W (a screw hole of the target object) at a time at which the target object W is imaged with the camera 30 and the target position acquisition unit 41b acquires the target position S_{tc} based on the target object W at the time. On the other hand, since the target object W at actual work is transported by the transport device 50, the target object W is moved in the y axis positive direction at a transport speed of the transport device 50. Accordingly, the tracking correction amount acquisition unit 41d acquires an output from the sensor included in the transport device 50 and acquires a movement amount of the target object W by the transport device 50 for each infinitesimal time ΔT.

Specifically, in synchronization with a time (the above-described subsequent time) assumed when the position control instruction acquisition unit 41c outputs the position S_{tc}, the tracking correction amount acquisition unit 41d estimates a movement amount of the target object at this time. For example, when a current time is time T+2ΔT, the position control instruction acquisition unit 41c outputs the target position S_{tc} at time T+3ΔT, and the tracking correction amount acquisition unit 41d outputs the movement amount of the target object W at time T+3ΔT as a correction amount Sₜₘ. The movement amount at time T+2ΔT can be acquired, for example, by estimating a movement amount at the infinitesimal time ΔT from the movement amount of the target object W from the imaging time T to the current time T+2ΔT and adding the estimated movement amount to the movement amount of the target object W from the imaging time T to the current time T+2ΔT. The instruction integration unit 43 adds the correction amount Sₜₘ to the target position S_{tc} to generate a movement target position Sₜₜ. The movement target position Sₜₜ corresponds to a control target value in the position control.

The force control unit 42 has a function of controlling a force acting on the TCP to the target force. The force control unit 42 includes a force control instruction acquisition unit 42a and acquires a target force f_{St} based on a command stored in the robot control device 40 in response to an operation of the teaching device 45. That is, the command indicates the target force f_{St} in each process in which force control is necessary in work and the force control instruction acquisition unit 42a acquires the target force f_{St} in a designated process. For example, when it is necessary to press the screw mounted on the tip end of the screw driver 21 in the work against the target object W by a given force, the target force f_{St} to act on the TCP is specified based on the force. Further, when it is necessary to perform control such that a force acting between the screw mounted on the tip end of the screw driver 21 and the target object W is 0 (collision avoiding and copying control), a force to act on the TCP in order for the force to become 0 is the target force f_{St}. In the case of the screw fastening work according to this example, the force control unit 42 performs copying control such that a force acting on the screw in the x and y axis directions by pressing the screw in the z axis negative direction by a given force is 0 (control such that a force in a plane including a movement direction of the target object is 0).

In this embodiment, the force control unit 42 performs gravity compensation on the acting force f_{S}. The gravity compensation is to remove components of a force or torque caused by the gravity from the acting force f_{S}. The acting force f_{S} by which the gravity compensation is performed can be seen as a force other than the gravity acting on the force sensor P.

When the acting force f_{S} other than the gravity acting on the force sensor P and the target force f_{St} to act on the TCP are specified, the force control unit 42 acquires a correction amount ΔS through impedance control. The impedance control according to this example is active impedance control in which virtual mechanical impedance is realized by the motors M1 to M6. The force control unit 42 applies the impedance control to a process in a contact state in which the end effector 20 receives a force from the target object W. In the impedance control, rotation angles of the motors M1 to M6 are derived based on the correction amount ΔS acquired by substituting the target force into equations of motion to be described below. Signals with which the robot control device 40 controls the motors M1 to M6 are signals subjected to pulse width modulation (PWM).

The robot control device 40 controls the motors M1 to M6 at rotation angles derived from the target position Sₜₜ by linear calculation in a process in a contactless state in which the end effector 20 receives no force from the target object W.

The instruction integration unit 43 has a function of controlling the robot 1 by one of the position control mode, the force control mode, and the position and force control mode, or a combination thereof. For example, in the screw fastening work illustrated in FIG. 1, since a “copying operation” is performed so that the target force is zero in the x axis k direction and the y axis direction, the force control mode is used. In the z-axis direction, since the screw is inserted into the screw hole while pressing the screw driver 21 with the non-zero target force, the position and force control mode is used. Further, since no copying or pressing is performed with respect to the rotation directions Rx, Ry, and Rz around the respective axes, the position control mode is used.

(1) Force control mode: Mode in which the rotation angle is derived from the target force based on an equation of motion and the motors M1 to M6 are controlled. The force control mode is control to execute feedback control on the target force f_{St} when the target position S_{tc} at each time does not change over time during work. For example, in the screw fastening work or fitting work to be described later, when the target position S_{tc} reaches the work end position, the target position S_{tc} does not change over time during the subsequent work, so that the work is executed in the force control mode. In the force control mode, the control device 40 according to this embodiment can also perform position feedback using the correction amount Sₜₘ according to the movement amount of transport of the target object W.

(2) Position control mode: Mode in which the motors M1 to M6 are controlled using a rotation angle derived from a target position by linear calculation.

The position control mode is control to execute feedback control on the target position S_{tc} when it is not necessary to control the force during work. In other words, the position control mode is mode in which the position correction amount ΔS by the force control is always zero. Also in the position control mode, the control device 40 according to this embodiment can perform position feedback using the correction amount Sₜₘ according to the movement amount by transport of the target object W.

(3) Position and force control mode: Mode in which the rotation angle derived from the target position by linear calculation and the rotation angle to be derived by substituting the target force into the equation of motion are integrated by linear combination and the motors M1 to M6 are controlled using the integrated rotation angle.

The position and force control mode is control to perform feedback control on the target position S_{tc} that changes over time and the position correction amount ΔS according to the target force f_{St} when the target position S_{tc} at each time changes over time during the work. For example, in grinding work or deburring work to be described later, when the work position with respect to the target object W changes over time (when a grinding position or a deburring position is not one point but has length or area), work is performed in the force control mode. The control device 40 according to this embodiment can perform position feedback using the correction amount Sₜₘ according to the movement amount of the target object W by transport also in the position and force control mode.

These modes can be switched autonomously based on a detected value of the force sensor P or detected values of the encoders E1 to E6 or may be switched in accordance with a command. In the force control mode or the position and force control mode, the robot control device 40 can drive the arm 10 so that the TCP takes a target attitude at the target position and the force acting on the TCP is the target force (the target force and the target moment).

More specifically, the force control unit 42 specifies a force-derived correction amount ΔS by substituting the target force f_{St} and the acting force f_{S} into an equation of motion of the impedance control. The force-derived correction amount ΔS means the size of the position S to which the TCP is moved in order to cancel a force deviation Δf_{S}(t) between the target force f_{St} and the acting force f_{S} when the TCP receives a mechanical impedance. Equation (1) below is an equation of motion for the impedance control.

mΔ\ddot{S}(t)+dΔ\dot{S}(t)+kΔS(t)=Δf_{S}(t) (1)

The left side of Equation (1) is configured by a first term in which a second-order differential value of the position S of the TCP is multiplied by a virtual inertial parameter m, a second term in which a differential value of the position S of the TCP is multiplied by a virtual viscosity parameter d, and a third term in which the position S of the TCP is multiplied by a virtual elastic parameter k. The right side of Equation (1) is configured by the force deviation Δf_{S}(t) obtained by subtracting the actual acting force f_{S} from the target force f_{St}. The differentiation on the right side of Equation (1) means differentiation by time. In the process of the work performed by the robot 1, a constant value is set as the target force f_{St} in some cases and a time function is set as the target force f_{St} in some cases.

The virtual inertial parameter m means a mass which the TCP virtually has, the virtual viscosity parameter d means viscosity resistance which the TCP virtually receives, and the virtual elastic parameter k means a spring constant of an elastic force which the TCP virtually receives. The parameters m, d, and k may be set as different values for each direction or may be set as common values irrespective of the directions.

When the force-derived correction amount ΔS is obtained, the instruction integration unit 43 converts an operation position in a direction of each axis defining the robot coordinate system into a target angle Dₜ which is a target rotation angle of each of the motors M1 to M6 based on the correspondent relation U1. Then, the instruction integration unit 43 calculates a driving position deviation Dₑ (Dₜ−Dₐ) by subtracting an output (the rotation angle Dₐ) of each of the encoders E1 to E6 which is an actual rotation angle of each of the motors M1 to M6 from the target angle Dₜ. Then, the instruction integration unit 43 obtains a driving speed deviation which is a difference between a value obtained by multiplying the driving position deviation Dₑ by a position control gain Kₚ and a driving speed which is a time differential value of the actual rotation angle Dₐ and multiplies this drive speed deviation by the speed control gain Kᵥ, thereby deriving a control amount D_{c}.

The position control gain Kₚ and the speed control gain Kᵥ may include not only a proportional component but also a control gain applied to a differential component or an integral component. The control amount D_{c} is specified in each of the motors M1 to M6. In the above-described configuration, the instruction integration unit 43 can control the arm 10 in the force control mode or the position and force control mode based on the target force f_{St}. The instruction integration unit 43 specifies an operation position (Sₜₜ+ΔS) by adding the force-derived correction amount ΔS to the movement target position Sₜₜ for each infinitesimal time.

As described above, the instruction integration unit 43 can control the robot 1 based on the correction amount Sₜₘ output from the tracking correction amount acquisition unit 41d in any of the position control mode, the force control mode, and the position and force control mode. As a result, the end effector 20 of the robot 1 moves in the direction (in this example, the y axis positive direction which is the movement direction of the target object W) designated by the correction amount Sₜₘ. For example, prior to the start of the screw fastening operation, the control in the position control mode is executed, and the screw driver 21 included in the end effector 20 moves to the target position (target position designated by a command) defined above the screw hole of the target object W. Then, when the screw fastening work is started, the control is executed by a combination of the three control modes. Specifically, in the x axis direction and the y axis direction, a “copying operation” is performed so as to set the target force to zero, so that the force control mode is used. In the z axis direction, since the screw is inserted into the screw hole while pressing the screwdriver 21 with the non-zero target force, the position and force control mode is used. Further, since no copying or pressing is performed with respect to the rotation directions Rx, Ry, and Rz around the respective axes, the position control mode is used. Also at this time, since the position correction is performed by the tracking correction amount Sₜₘ, the screw driver 21 is moved to follow movement in the y axis positive direction of the target object W (relative movement speed between the target object W and the screw driver 21 in the y axis positive direction is substantially 0).

According to the force control according to this embodiment, the robot 1 is controlled such that no force acts in the x and y axis directions even when the screw is pressed in the z axis negative direction by a constant force and the screw hole of the target object W and the screw come into contact with each other in a case in which the screw mounted on the screw driver 21 comes into contact with the target object W. Thus, when the force control is started, the robot control device 40 outputs a control signal to the screw driver 21 to rotate the screw driver 21. When the screw is pressed against the target object W in the z axis negative direction by a constant force, a force acts on the target object W in the z axis negative direction. This force acts in a direction different from the y axis positive direction which is the movement direction of the target object. Accordingly, in this embodiment, during the movement of the end effector 20 in the y axis positive direction which is the movement direction of the target object, a force oriented in the z axis negative direction different from the movement direction acts on the target object W.

The robot control device 40 causes the end effector 20 to follow the target object W by obtaining the movement target position Sₜₜ by adding the correction amount Sₜₘ representing the movement amount by transport to the target position S_{tc} when the movement amount of the object W by transport is not considered. Then, when the screw fastening work is started, the robot control device 40 corrects the coordinates of the target position Sₜ in the z axis direction to coordinates of the TCP at the time of completing the screw fastening. In this case, the robot control device 40 acquires a control instruction to move the robot 1 to the target position not only in the y axis direction but also in the z axis direction by the function of the position control instruction acquisition unit 41c and the instruction integration unit 43 controls the robot 1 such that the robot 1 is also moved to the target position in the z axis direction. Accordingly, the screw fastening work is performed by moving the TCP toward the target position in the z axis direction in a state in which a constant force acts in the z axis negative direction while the screw driver 21 is rotated. When the TCP reaches the target position in the z axis direction, the screw fastening work on one screw hole ends. As such, in the screw fastening operation, control is executed by one of three control modes for each direction.

The target position S_{tc} described above corresponds to “a target position when it is assumed that the target object is stopped”, the correction amount Sₜₘ corresponds to “a first position correction amount representing the movement amount of the target object”, the force-derived correction amount ΔS corresponds to “a second position correction amount calculated by force control”, and the movement target position Sₜₜ corresponds to “a control target position obtained by adding the first position correction amount and the second position correction amount to the target position”.

In the above-described control, the robot control device 40 moves the end effector 20 in a direction parallel to the movement direction of the target object W (y axis direction) in order for the end effector 20 to move to follow the target object W. Further, in order to control the force acting on the TCP to the target force, the end effector 20 is moved in the direction (z axis direction) perpendicular to the movement direction of the target object W. According to this configuration, it is possible to perform work accompanying movement in a direction perpendicular to the movement direction of the target object W.

According to the foregoing configuration, it is possible to control the force acting on the TCP to the target force such that the work by the end effector 20 is performed while moving the end effector 20 to follow the target object W. Therefore, when an interaction such as contact between the end effector 20 and the target object W occurs in the work on the end effector 20, the force acting on the TCP becomes the target force. Since the target force is a force necessary for the work on the target object W, the screw fastening work can be performed without interfering in the movement of the target object even during the movement of the target object according to the foregoing configuration. Therefore, the screw fastening work can be performed without temporarily stopping the transport device or evacuating the target object from the transport device. In addition, a work space for the evacuation is not necessary either.

Further, in this embodiment, since the force control is performed in addition to the position control, the work can be performed by absorbing various error factors. For example, an error can be included in the movement amount of the target object W detected by the sensor of the transport device 50. An error is also included in fluctuation of the transport plane of the transport device 50 or the position of the target object W specified from an image captured by the camera 30. Further, when the work is performed on the plurality of target objects W, errors (variations in the sizes or shapes of screw holes) in design can occur in the individual target objects W. Further, a change such as abrasion can also occur in a tool such as the screw driver 21.

Accordingly, only when the robot 1 is caused to follow movement of the screw hole through the position control, it is difficult to appropriately continue the screw fastening work on the plurality of target objects. However, such an error can be absorbed by the force control. For example, even when a relation between the position of the TCP and the target position deviates from an ideal relation, since the forces in the x and y axis directions are controlled such that the forces become 0 when the screw is close to the screw hole, even when there is an error, the robot is moved without hindering insertion of the screw into the screw hole (the forces in the x and y axis directions become 0). Therefore, it is possible to perform the screw fastening work while absorbing various errors.

A user can teach the target position and the target force of each work process with the teaching device 45 according to this embodiment, and thus the above-described command is generated based on the teaching. The teaching by the teaching device 45 may be given various aspects. For example, the target position may be taught by the user moving the robot 1 with his or her hands. The target position may be taught by designating coordinates in the robot coordinate system with the teaching device 45.

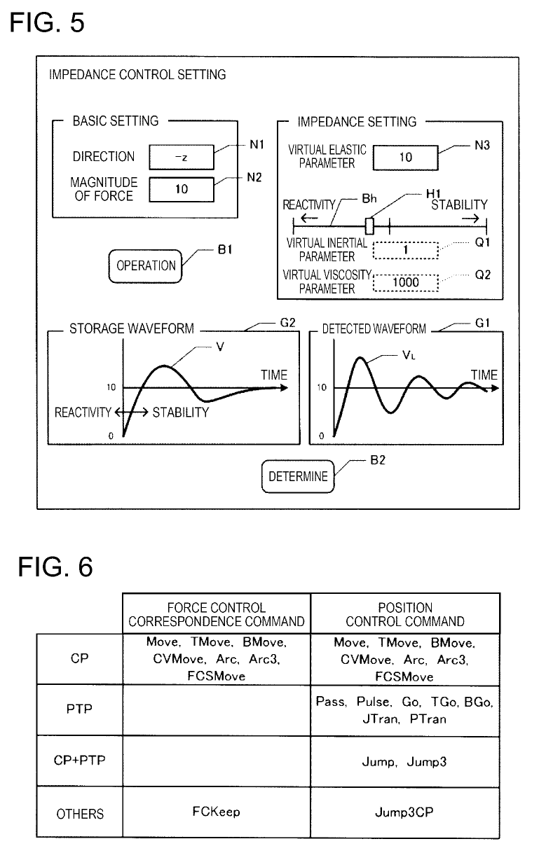

FIG. 5 illustrates an example of the GUI of the teaching device 45. The target force f_{St} can be taught in various aspects. Parameters m, d, and k of the impedance control may also be able to be taught along with the target force f_{St}. For example, a configuration may be realized in which the teaching can be given using a GUI illustrated in FIG. 5. That is, the teaching device 45 can display the GUI illustrated in FIG. 5 on a display (not illustrated) and an input using the GUI can be received by an input device (not illustrated). For example, the GUI is displayed in a state in which the TCP is moved up to a start position of the work using the force control by the target force f_{St} and the actual target object W is disposed. As illustrated in FIG. 5, the GUI includes input windows N1 to N3, a slider bar Bh, display windows Q1 and Q2, graphs G1 and G2, and buttons B1 and B2.

In the GUI, the teaching device 45 can receive the direction of the force (the direction of the target force f_{St}) and the magnitude of the force (the magnitude of the target force f_{St}) on the input windows N1 and N2. That is, the teaching device 45 receives an input in the direction of one of the axes defining the robot coordinate system on the input window N1. The teaching device 45 receives an input of any numeral value as the magnitude of the force on the input window N2.

Further, in the GUI, the teaching device 45 can receive the virtual elastic parameter k in accordance with a numerical value input on the input window N3. When the virtual elastic parameter k is received, the teaching device 45 displays a storage waveform V corresponding to the virtual elastic parameter k in the graph G2. The horizontal axis of the graph G2 represents a time and the vertical axis of the graph G2 represents an acting force. The storage waveform V is a time response waveform of the acting force and is stored for each virtual elastic parameter k in the storage medium of the teaching device 45. The storage waveform V is a waveform converging to the force with the magnitude received on the input window N1. The storage waveform V is a time response wave of a case in which a force which actually acts on the TCP is acquired based on the force sensor P when the arm 10 is controlled so that the force with the magnitude received on the input window N2 acts on the TCP in general conditions. When the virtual elastic parameter k is different, the shape (slope) of the storage waveform V is considerably different. Therefore, the storage waveform V is assumed to be stored for each virtual elastic parameter k.

Further, in the GUI, the teaching device 45 receives the virtual viscosity parameter d and the virtual inertial parameter m in response to an operation on the slider H1 on the slider bar Bh. In the GUI of FIG. 5, the slider bar Bh and the slider H1 which is slidable on the slider bar Bh are installed as a configuration for receiving the virtual inertial parameter m and the virtual viscosity parameter d. The teaching device 45 receives an operation of sliding the slider H1 on the slider bar Bh. In the slider bar Bh, the fact that stability is set to be emphasized as the slider H1 is further moved to the right side, and reactivity is set to be emphasized as the slider H1 is further moved to the left side is displayed.

The teaching device 45 acquires a slide position of the slider H1 on the slider bar Bh and receives the virtual inertial parameter m and the virtual viscosity parameter d corresponding to the slide position. Specifically, the teaching device 45 receives setting of the virtual inertial parameter m and the virtual viscosity parameter d so that a ratio of the virtual inertial parameter m to the virtual viscosity parameter d is constant (for example, m:d=1:1000). The teaching device 45 displays the virtual inertial parameter m and the virtual viscosity parameter d corresponding to the slide position of the slider H1 on the display windows Q1 and Q2.

Further, the teaching device 45 controls the arm 10 by a current setting value in response to an operation on the button B1. That is, the teaching device 45 outputs the parameters m, d, and k of the impedance control and the target force f_{St} set in the GUI to the robot control device 40 and teaches the robot control device 40 to control the arm 10 based on the setting value. In this case, a detected value of the force sensor P is transmitted to the teaching device 45, and the teaching device 45 displays a detection waveform VL of a force acting on the TCP based on the detected value on the graph G1. The user can perform an operation of setting the target force f_{St} and the parameters m, d, and k of the impedance control by comparing the storage waveform. V to the detection waveform VL.

In this way, when the target position, the target force, and the parameters m, d, and k of the impedance control in each process are set, the teaching device 45 generates a robot control program described in commands in which the target position, the target force, and the parameters m, d, and k of the impedance control are arguments in the robot control device 40. When the robot control program is loaded to the robot control device 40, the robot control device 40 can perform control in accordance with designated parameters.

The robot control program is described in accordance with a predetermined program language and is converted into a machine language program through an intermediate language in accordance with a translation program. The CPU of the robot control device 40 executes the machine language program at a clock cycle. The translation program may be executed by the teaching device 45 or may be executed by the robot control device 40. A command of the robot control program is configured by a body and an argument. The command includes an operation control command causing the arm 10 or the end effector 20 to operate, a monitor command to read a detected value of the encoder or the sensor, a setting command to set various variables, and the like. In the present specification, execution of a command is synonymous with execution of a machine language program translated by the command.

FIG. 6 illustrates an example of the operation control command (body). As illustrated in FIG. 6, the operation control command includes a force control correspondence command to enable the arm 10 to operate in the force control mode and a position control command to disable the arm 10 to operate in the force control mode. In the force control correspondence command, the force control mode can be designated as being turned on by an argument. When the force control mode is not designated as being turned on by the argument, the force control correspondence command is executed in the position control mode. When the force control mode is designated as being turned on by the argument, the force control correspondence command is executed in the force control mode. The force control correspondence command is executable in the force control mode and the position control command is not executable in the force control mode. Syntax error checking is performed by the translation program so that the position control command is not executed in the force control mode.

Further, in the force control correspondence command, continuation of the force control mode can be designated by an argument. When the continuation of the force control mode is designated by the argument in the force control correspondence command executed in the force control mode, the force control mode continues. When the continuation of the force control mode is not designated by the argument, the force control mode ends until the execution of the force control correspondence command is completed. That is, even when the force control correspondence command is executed in the force control mode, the force control mode autonomously ends according to the force control correspondence command and the force control mode does not continue after the end of the execution of the force control correspondence command as long as the continuation is not explicitly designated by an argument. In FIG. 6, “CP” indicates classification of commands capable of designating movement directions, “PTP” indicates classification of commands capable of designating target positions, and “CP+PIP” indicates classification of commands capable of designating movement directions and target positions.

### (2) Screw Fastening Process

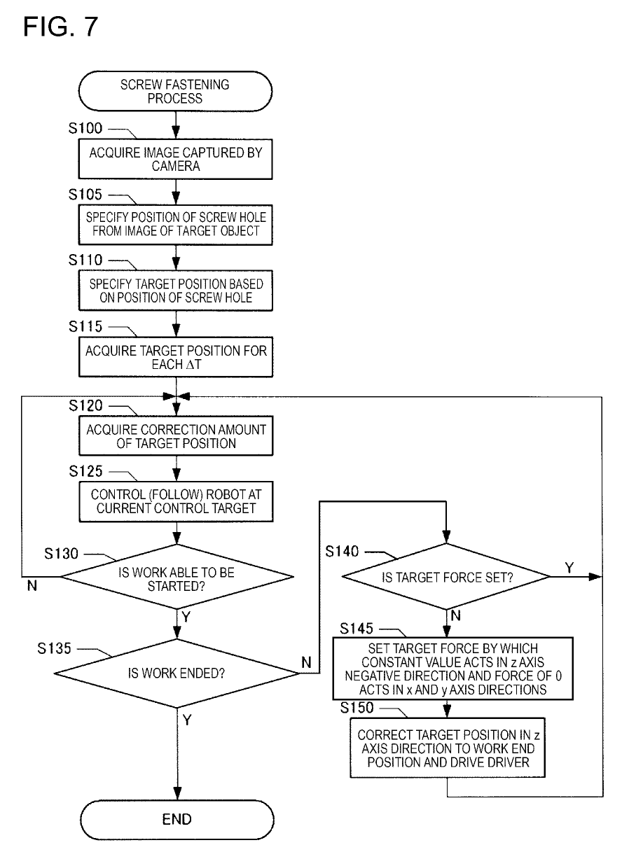

FIG. 7 is a flowchart of the screw fastening process. The screw fastening process is realized by processes performed by the position control unit 41, the force control unit 42, and the instruction integration unit 43 in accordance with the robot control program described by the above-described commands and a process performed by the position control unit 41 according to operations of the camera 30 and the transport device 50. The screw fastening process in this embodiment is performed when transport of the target object W by the transport device 50 is started. When the screw fastening process is started and the target object W enters an imageable state within the field of view of the camera 30, an image obtained by imaging the target object W by the camera 30 is output. Then, the robot control device 40 acquires the image captured by the camera through the process of the target object position acquisition unit 41a (step S100).

Subsequently, the robot control device 40 specifies the position of the screw hole from the image of the target object W by the function of the target position acquisition unit 41b (step S105). That is, the robot control device 40 specifies the position (x-y coordinates) of the screw hole based on a feature amount of the image acquired in step S100, a result of a pattern matching process, and design information (design position information of the screw hole) in the target object W.

Subsequently, the robot control device 40 acquires the target position Sₜ based on the position of the screw hole specified in step S105 and the command by the function of the target position acquisition unit 41b (step S110). That is, the position of the transport plane of the transport device 50 in the z axis direction is specified in advance and the height (the length in the z axis direction) of the target object W is also specified in advance. Accordingly, when the x-y coordinates of the screw hole are specified in step S105, the xyz coordinates of the screw hole are also specified. Since the position of the screw hole taught as a work start position is described as a position offset from the screw hole in the z axis positive direction by a command, the robot control device 40 specifies the position of the TCP for disposing the screw at the position offset in the z axis positive direction at the xyz coordinates of the screw hole as the target position Sₜ.

Subsequently, the robot control device 40 acquires the target position S_{tc} for each infinitesimal time ΔT by the function of the position control instruction acquisition unit 41c (step S115). That is, the time interval from an imaging time of the target object W by the camera 30 to a movement completion time in which movement to the target position Sₜ designated by a command is completed is divided for each infinitesimal time. Then, the position control instruction acquisition unit 41c specifies the target position S_{tc} of the TCP at each time at which the position of the TCP at the imaging time of the target object W by the camera 30 is moved to the target position Sₜ designated by the command for a period until the movement completion time. That is, the position control instruction acquisition unit 41c acquires the target position S_{tc} at each infinitesimal time for sequentially approaching the TCP to a final target position Sₜ based on the final target position Sₜ for each process.

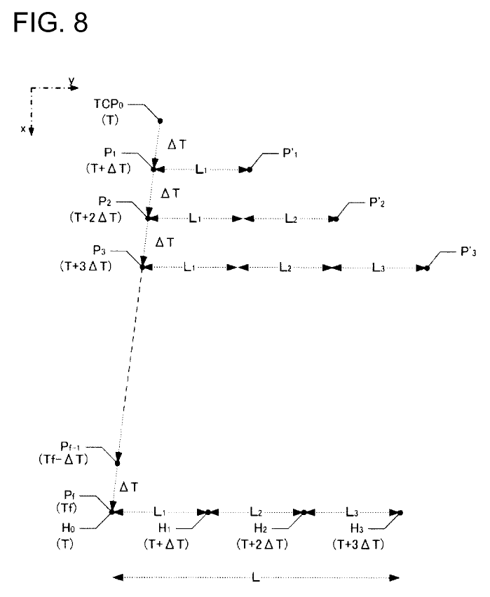

FIG. 8 is a diagram schematically illustrating a relation between the screw hole H and the TCP. FIG. 8 illustrates an example of a case in which a screw hole H₀ at the imaging time T by the camera 30 is moved as H₁ and H₂ at times T+ΔT, T+2ΔT, and T+3ΔT. The position of the TCP at the imaging time T is TPC₀. In this example, for simplicity, an example in which the final target position Sₜ of the TCP in the exemplified process is identical to the x-y coordinates of the screw hole H is illustrated. That is, an example in which the TCP overlaps with the screw hole H when the TCP reaches the final target position Sₜ on the x-y plane illustrated in FIG. 8 will be described.

In this example, the robot control device 40 divides a period from the imaging time T to the movement completion time Tf at which the TCP reaches the screw hole H₀ for each infinitesimal time ΔT and specifies the target position at each time. In FIG. 8, target positions P₁, P₂, P₃, . . . , P_{f-1}, and P_{f} at T+ΔT, T+2ΔT, T+3ΔT, . . . , Tf−ΔT, and Tf are acquired. At each time, the position control instruction acquisition unit 41c outputs the target position S_{tc} at a subsequent time. For example, at time T+2ΔT, the position control instruction acquisition unit 41c outputs the target position P₃ at time T+3ΔT as the target position S_{tc}.

Next, the robot control device 40 acquires the correction amount Sₜₘ of the target position by the function of the tracking correction amount acquisition unit 41d (step S120). The robot control device 40 acquires a movement amount until the present after the imaging time T by the camera 30, estimates a movement amount of the target object W from the present to the infinitesimal time ΔT based on the movement amount, and acquires the movement amount as the correction amount Sₜₘ of the target position, in step S120 when repeating the processes of steps S120 to S130 every ΔT period. For example, when the current time is time T+2ΔT illustrated in FIG. 8, the tracking correction amount acquisition unit 41d acquires the movement amount of the target object W at time T+3ΔT as the correction amount Sₜₘ.

Here, the movement amount of the target object W at time T+3ΔT is a movement amount (L indicated in FIG. 8) after the imaging time T. Accordingly, the tracking correction amount acquisition unit 41d estimates a movement amount L₃ at a subsequent infinitesimal time ΔT from a movement amount (L₁+L₂) of the target object W from the imaging time T to the current time T+2ΔT and acquires the movement amount L by adding the movement amount L₃ to the movement amount (L₁+L₂) of the target object W from the imaging time T to the current time T+2ΔT. The movement amount L at each time is the correction amount Sₜₘ output from the tracking correction amount acquisition unit 41d at each time.

Subsequently, the robot control device 40 controls the robot 1 at a current control target (step S125). When the control target includes the movement target position Sₜₜ of the position control and the target force f_{St} of the force control and the target force f_{St} of the force control is not set, the robot control device 40 moves the TCP with the parameters at the current time in the position control mode. That is, the position control instruction acquisition unit 41c outputs the target position S_{tc} of the TCP at a subsequent time of the current time based on the target position for each infinitesimal time ΔT acquired in step S115. The tracking correction amount acquisition unit 41d outputs the correction amount Sₜₘ of the position of the TCP at the current time acquired in step S120.

Then, the robot control device 40 controls the robot 1 based on the target position Sₜₜ obtained by integrating the position S_{tc} and the correction amount Sₜₘ by the function of the instruction integration unit 43 such that the TCP is moved to the target position Sₜₜ of the current time. As a result, the robot 1 (the screw driver 21) enters a state in which the robot 1 is moved to follow the transport of the target object W by the transport device 50. In FIG. 8, positions P′₁, P′₂, and P′₃ indicate positions to which the TCP is moved as a result obtained by correcting the target positions P₁, P₂, and P₃ for each infinitesimal time with correction amounts L₁, (L₁+L₂), and (L₁+L₂+L₃). In this way, according to this embodiment, position control is performed in a state in which the position control in which the TCP faces above the screw hole H₀ as the final target position for each process and the position control in which the transport of the transport device 50 is followed are combined.

When the target force f_{St} of the force control is set, the robot control device 40 acquires an output of the force sensor P by the function of the force control instruction acquisition unit 42a and specifies the acting force f_{S} currently acting on the TCP. Then, the robot control device 40 compares the acting force f_{S} to the target force f_{St} by the function of the force control instruction acquisition unit 42a and acquires a control instruction (the force-derived correction amount ΔS) to move the robot 1 so that the acting force f_{S} becomes the target force f_{St} when the acting force f_{S} is different from the target force f_{St}. The robot control device 40 integrates both the control instruction (the target position Sₜₜ) of the position control and the control instruction (the force-derived correction amount ΔS) of the force control by the function of the instruction integration unit 43 and outputs the integrated instructions to the robot 1. As a result, the screw fastening work accompanying the force control is performed in the state in which the robot 1 follows the movement of the target object W by the transport device 50.

Subsequently, the robot control device 40 determines whether the screw fastening work can be started by the function of the instruction integration unit 43 (step S130). That is, the work (process) accompanied by the force control can be started in a state in which the end effector 20 has a given relation (the position and the attitude) with respect to the target object W. Therefore, in this embodiment, the configuration is realized in which it is determined whether the given relation is realized while the robot 1 is moved to follow the movement of the target object W and the work is started when it is determined that the given relation is realized. In this embodiment, the control is executed in the position control mode before the work is started, and the control is executed in the force control mode after the work is started.

Whether the work can be started may be determined based on various indexes. For example, a configuration can be adopted in which information for determining whether the work can be started is detected by a sensor or the like. The sensor may have any of various configurations, may be a camera, a distance sensor, or the like that detects electromagnetic waves having various wavelengths, or may be the force sensor P or the like. The camera or the distance sensor may be mounted on any position. For example, a configuration can be adopted in which the camera or the distance sensor is mounted on the end effector 20 or the screw driver 21 so that the target object W before the start of the work is included in a detection range.

When the force sensor P is used, for example, a configuration can be exemplified in which an unscheduled force is not detected when a tool such as the screw driver 21 approaches the target object W, and the robot control device 40 determines that the work can be started when a force is detected within a scheduled range. When an output of any of various sensors is stabilized, it may be determined that the work can be started. When a predetermined time has elapsed after arrival to the final target position (for example, above the screw hole in the case of the screw hole) of the process before the start of the work, it may be determined that the work can be started. According to this configuration, the work is not started before completion of preparation and it is possible to reduce a possibility of occurrence of a work failure.

When it is determined in step S130 that the screw fastening work may not be started, the robot control device 40 repeats step S120 and the subsequent processes. That is, step S120 and the subsequent processes are repeated until the robot 1 is moved to follow the target object W and stably follows the target object W in a state in which the TCP is at the position above the screw hole at which the work can be started.

When it is determined in step S130 that the screw fastening work can be started, the robot control device 40 determines whether the work ends (step S135). The end of the work can be determined with various determination factors. For example, a configuration can be adopted in which it is determined that the work ends when the insertion of the screw into the screw hole is completed, when the robot 1 reaches the target position in the z axis direction, or when the screw is fastened with appropriate torque by the screwdriver 21. When it is determined in step S135 that the screw fastening work ends, the robot control device 40 ends the screw fastening process.

On the other hand, when it is determined in step S135 that the screw fastening work does not end, the robot control device 40 determines whether the target force f_{St} is set (step S140). When it is determined in step S140 that the target force f_{St} is set, the robot control device 40 repeats step S120 and the subsequent processes.

On the other hand, when it is determined in step S140 that the target force f_{St} is not set, the robot control device 40 sets the target force f_{St} by which a constant value in the z axis negative direction and a force of 0 in the x and y axis directions act on the screw by the function of the force control instruction acquisition unit 42a (step S145). That is, the robot control device 40 sets a force to act on the TCP as the target force f_{St} in order for the constant value in the z axis negative direction and the force of 0 in the x and y axis directions to act on the screw by the function of the force control instruction acquisition unit 42a. As a result, the force control unit 42 enters a state in which the correction amount ΔS specified based on the impedance control can be output. Accordingly, when step S125 is performed in this state, the force control in which the force acting on the TCP is set to the target force f_{St} is performed.

Subsequently, the robot control device 40 corrects the target position in the z axis direction to a work end position and drives the screw driver 21 (step S150). That is, the robot control device 40 specifies a position at the time of completing the screw fastening based on a command by the function of the target position acquisition unit 41b and corrects the target position in the z axis direction to this position. Since a target position in the y axis direction is corrected over time with the correction amount Sₜₘ corresponding to the movement amount of the target object W in step S120, the screw driver 21 follows the target object W in the y axis direction in step S125 after the correction of step S150. Further, in step S150, the robot control device 40 outputs a control signal to the screw driver 21 and rotates the screwdriver 21 by the function of the instruction integration unit 43.

When step S150 is performed and subsequently steps S120 to S140 are repeated, the robot control device 40 causes the instruction integration unit 43 to move the robot 1 in the z axis direction while moving the robot 1 in the y axis direction in step S125 (in this process, the screwdriver 21 is rotated). Then, in a state in which the screw at the tip end of the screw driver 21 comes into contact with the screw hole, control is performed such that a constant force acts in the z axis negative direction and forces in the x and y axis directions become 0. Therefore, the screw is inserted into the screw hole without being obstructed by the movement of the target object W.

### (3) Other Embodiments

The foregoing embodiment is an example for carrying out the present invention and other various embodiments can be adopted. For example, parts of the configurations of the above-described embodiment may be omitted and processing procedures may be changed or omitted. Further, in the above-described embodiment, the target position Sₜ or the target force f_{St} is set for the TCP, but the target position or the target force may be set in another position, for example, the origin of the sensor coordinate system for the force sensor P or the tip end of the screw.

Further, the position, the movement direction, and the movement speed of the target object W may be acquired based on a plurality of images (for example, a moving image) captured by the camera. Further, the transport path by the transport device may not be straight. In this case, the position of the target object or a movement speed of the target object along the transport path is complemented by the sensor or the like. Further, screw fastening work may be performed on a plurality of screw holes existing in a target object. In this case, after the screw fastening work ends on one screw hole, the screw fastening work is performed on the other screw holes. Therefore, a process of complementing current positions of the other screw holes is performed. For example, after the plurality of screw holes are specified in step S105, the current position of each screw hole may be continuously complemented. The current positions of the other screw holes may be specified by specifying positions at which the other screw holes exist when viewed from the current position of one screw hole from design information or the like.

The robot may operate by the force control or work on a target object may be performed by a movable unit in any aspect. The end effector is a portion used in the work on the target object and any tool may be mounted on the end effector. The target object may be an object which is a work target of the robot, may be an object gripped by the end effector, or may be an object handled by a tool included in the end effector. Any of various objects may be a target object.

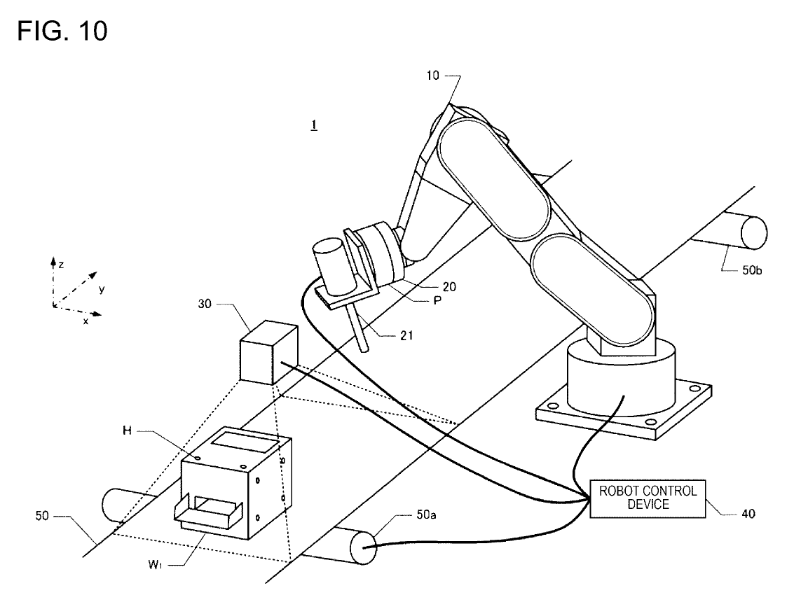

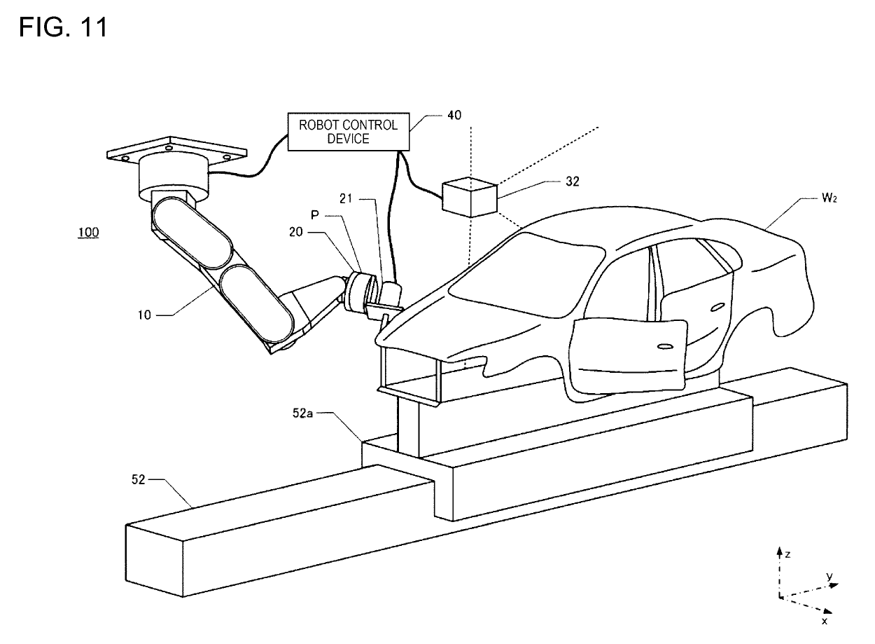

FIGS. 10 and 11 are diagrams illustrating examples of target objects. In the drawings, the same reference numerals are given to the same configuration of FIG. 1. FIG. 10 illustrates an example of a printer which is a target object W₁. The robot 1 performs the screw fastening work to mount the outer frame of a casing on the body of the target object Wd1. That is, the robot control device 40 specifies screw holes H of the target object W₁ captured by the camera 30. The robot control device 40 controls the robot 1 and causes the end effector 20 (the screw driver 21) to follow movement of the screw holes H accompanied by transport by the transport device 50. Then, the robot control device 40 causes the robot 1 to perform the screw fastening work under control accompanying the force control. As a result, the work can be performed without disturbing the movement of the target object.

FIG. 11 illustrates an example of a vehicle which is a target object W₂. A robot 100 performs screw fastening work on a screw hole (not illustrated) included in the vehicle which is the target object W₂ by the screw driver 21. In the example illustrated in FIG. 11, a transport device 52 can load the vehicle on a transport stand 52a during manufacturing and transport the vehicle in the y axis negative direction. A camera 32 has a field of view oriented toward the y-z plane, as indicated by a dotted line, and can image the vehicle which is being transported by the transport device 52. The robot 100 is installed on a ceiling, a beam, a wall, or the like in a vehicle manufacturing factory.

In this configuration, the robot control device 40 specifies a screw hole of the target object W₂ imaged by the camera 30. The robot control device 40 controls the robot 100 to cause the end effector 20 (the screw driver 21) to follow the movement of the screw hole H accompanied by the transport by the transport device 50. Then, the robot control device 40 causes the robot 100 to perform the screw fastening work under the control accompanying the force control. As a result, the work can be performed without disturbing the movement of the target object. In FIG. 11, a connection line between the robot control device 40 and the transport device 500 is not illustrated. As described above, various work targets can be assumed.

A configuration in which the movable unit of the robot is moved relatively to the installation position of the robot and the attitude is changed may be realized and the degree of freedom (the number of movable axes or the like) is arbitrary. The types of robots may be various and may be an orthogonal robot, a horizontally articulated robot, a vertically articulated robot, a double-arm robot or the like. Of course, various types can be adopted for the number of axes, the number of arms, the type of the end effector, and the like.

The target force acting on the robot may be a target force which acts on the robot when the robot is driven by the force control. For example, when a force detected by a force detection unit such as a force sensor, a gyro sensor, or an acceleration sensor (or a force calculated from the force) is controlled to a specific force, the force is the target force.

The force which acts on the target object by the force control can be a force in an arbitrary direction, and in particular, it is preferable to use a force in a direction different from the movement direction of the target object. For example, when the target object is moved in the y axis positive direction, a force oriented in the y axis negative direction can be included and various forces in directions different from the y axis positive direction can be forces to act on the target object by the force control. In any case, the work may be performed on the target object by the force control by causing the forces to act on the target object. The mode in which the force acting on the target object by force control is a force in a direction different from the movement direction of the target object is preferable in that the force control can be executed more accurately.

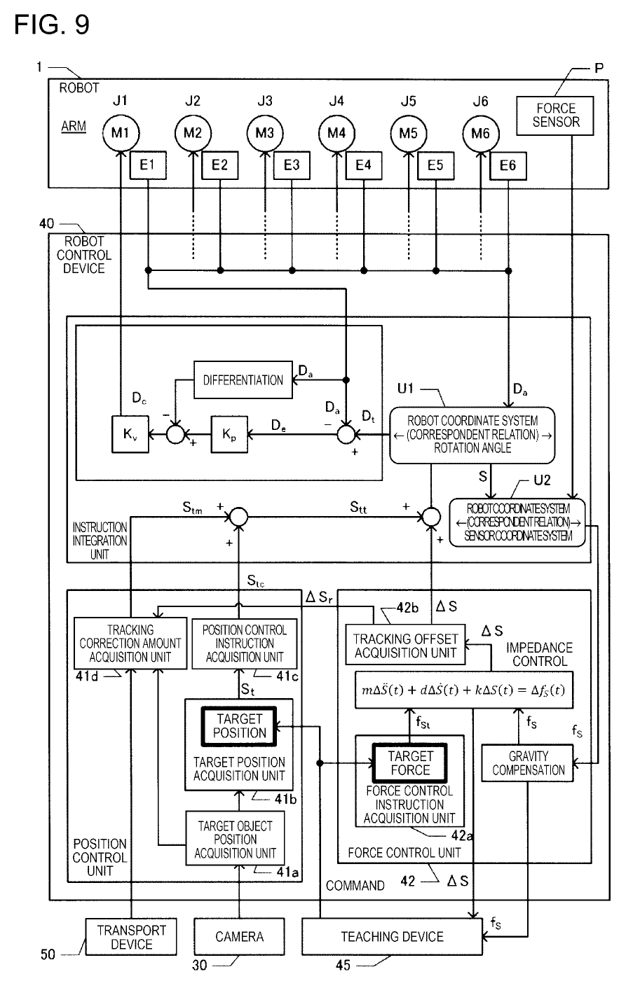

FIG. 9 is a functional block diagram illustrating another configuration example of the robot control device 40. Here, in order to use the control result by force control for control of the next and subsequent target objects, a tracking offset acquisition unit 42b is added in the force control unit 42. When the force control for setting the force acting on the robot as the target force is performed, the tracking offset acquisition unit 42b acquires the force-derived correction amount ΔS which is the movement amount necessary for the force control and determines a representative correction amount ΔSᵣ according to the history of the force-derived correction amount ΔS in the past force control. The representative correction amount ΔSᵣ is supplied to the tracking correction amount acquisition unit 41d. When the end effector 20 is caused to follow a new target object, the tracking correction amount acquisition unit 41d adds the representative correction amount ΔSᵣ to the movement amount of the target object W specified as usual to obtain the position correction amount Sₜₘ. The tracking offset acquisition unit 42b may be provided in the position control unit 41.

The reason for using the representative correction amount ΔSᵣ representing the force-derived correction amount ΔS in past force control is as follows. The force control to set the force acting on the robot as the target force brings the current force closer to the target force by moving the end effector 20 when the current force is different from the target force. Then, when the same work is executed for the target object of the same shape and size a plurality of times, the force-derived correction amount ΔS by the force control can be reproduced. Therefore, if the representative correction amount ΔSᵣ corresponding to the force-derived correction amount ΔS that can be reproduced in the force control is added to the movement amount of the target object at the time of performing the position control, instead of force control, to cause the end effector 20 to follow the target object, it becomes possible to realize the correction necessary for the force control by the position control. Therefore, the control on the new target object becomes a simple control, and the cycle time of work can be shortened. The representative correction amount ΔSᵣ of the force control may be specified by various methods, and may be, for example, a statistical value (for example, average or median) of the force-derived correction amount ΔS in multiple force control. As another example of the statistical value, when dispersion or standard deviation of the force-derived correction amount ΔS by the force control converges within a predetermined range, a force-derived correction amount ΔS (that is, the most frequent value) corresponding to the peak of the distribution of the force-derived correction amount ΔS can be adopted.

Further, the configuration for the control illustrated in FIG. 4 or 9 described above is an example and another configuration may be adopted. For example, a configuration in which the target position is corrected with a correction amount by movement of the target object W by the transport device 50 when the target position Sₜ is acquired by the target position acquisition unit 41b may be realized. Further, a configuration in which the control amount is corrected to follow the movement of the target object W by the transport device 50 when control amounts of the motors M1 to M6 are acquired by the instruction integration unit 43 may be realized.

Further, the work which can be carried out in the embodiments is not limited to the screw fastening, and various other works can be carried out. Hereinafter, as another embodiment, mode of performing the following three works will be sequentially described.

### (a) Fitting Work:

Work of fitting a fitting object gripped by a gripping unit included in the end effector to a fitting portion formed on the target object

### (b) Grinding Work:

Work of grinding the target object by a grinding tool included in the end effector

### (c) Deburring Work:

Work of removing a burr of the target object by a deburring tool included in the end effector

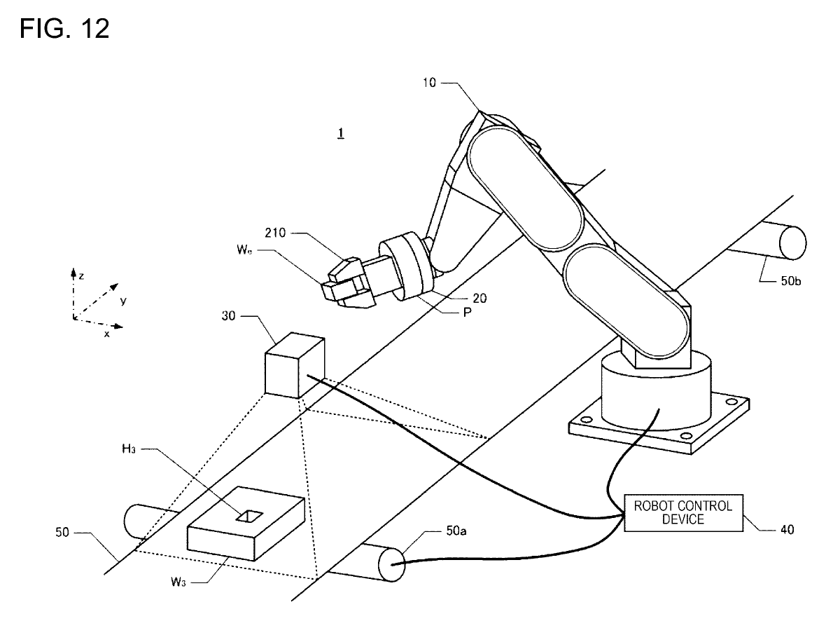

FIG. 12 illustrates a robot system performing the fitting work, and illustrates a configuration in which a gripper 210 is mounted on the end effector 20 of the robot 1 illustrated in FIG. 1. In the configuration illustrated in FIG. 12, a configuration other than the gripper 210 is the same as the configuration of the robot 1 illustrated in FIG. 1.

When the gripper 210 is mounted on the end effector 20, work can be performed using an object gripped by the gripper 210 on the target object transported by the transport device 50. In the example illustrated in FIG. 12, a fitting hole H₃ is formed on the upper surface of a target object W₃ (a surface on which the camera 30 performs imaging) and the robot 1 performs work to fit a fitting object We gripped by the gripper 210 in the fitting hole H₃.

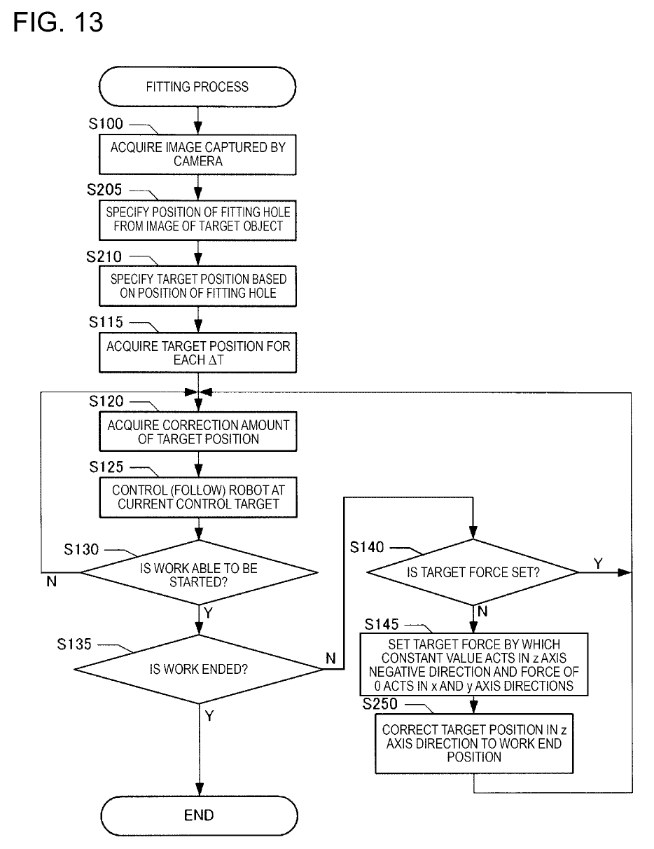

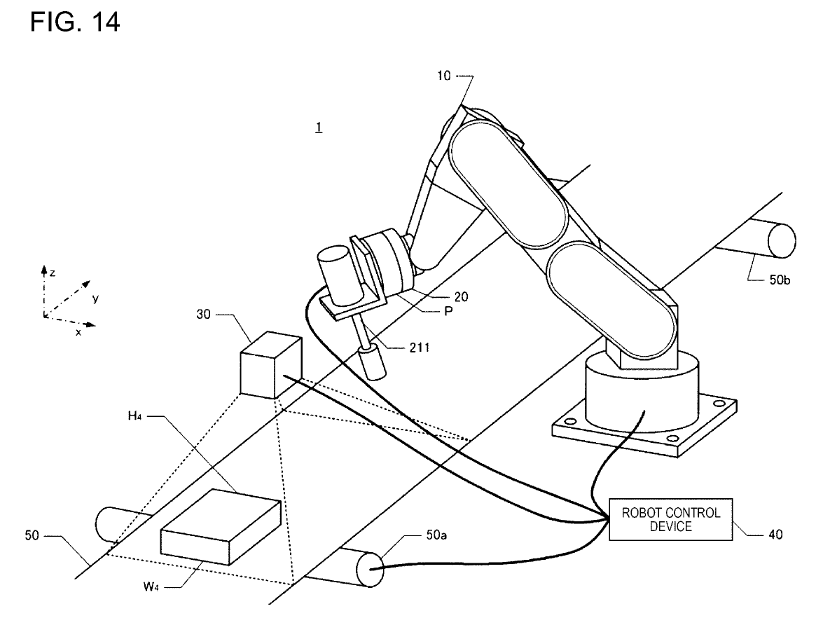

FIG. 13 is a flowchart illustrating an example of the fitting process performed by the fitting work illustrated in FIG. 12. The fitting process is performed when transport of the target object W₃ by the transport device 50 is started. The flowchart of FIG. 13 is substantially the same as the flowchart of FIG. 7 except for steps S205, S210, and S250. Since the process of FIG. 13 can be understood by replacing the “screw fastening work” as “fitting work”, replacing the “screw hole” as a “fitting hole”, and replacing the “screw driver 21” as the “gripper 210” in the process of FIG. 7, respectively, hereinafter, contents of step S250 will mainly be described.

In step S145 of FIG. 13, the robot control device 40 sets a force to act on the TCP as the target force f_{St} in order for a constant value in the negative direction of the z axis and the force of 0 in the, x and y axis directions to act on the fitting object Wₑ by the function of the force control instruction acquisition unit 42a.

Subsequently, the robot control device 40 corrects the target position in the z axis direction to a work end position (step S250). That is, the robot control device 40 specifies a position at the time of completing the fitting based on a command by the function of the target position acquisition unit 41b and corrects the target position in the z axis direction to this position. Since a target position in the y axis direction is corrected over time in step S120, the target position is set in step S125 after the correction of step S250 so that the gripper 210 follows the target object W₃ in the y axis direction the gripper 210 descends in the direction of the fitting hole in the z axis direction.

When step S250 is performed and subsequently steps S120 to S140 are repeated, the robot control device 40 causes the instruction integration unit 43 to move the robot 1 in the z axis direction while moving the robot 1 in the y axis direction in step S125. Then, in a state in which the fitting object We comes into contact with the fitting hole H₃, control is performed such that a constant force acts in the z axis negative direction and forces in the x and y axis directions become 0. Therefore, the fitting object We is inserted into the fitting hole without being hindered by the movement of the target object W₃.

FIG. 14 illustrates a robot system performing the grinding work and illustrates a configuration in which a grinder 211 is mounted on the end effector 20 of the robot 1 illustrated in FIG. 1. In the configuration illustrated in FIG. 14, a configuration other than the grinder 211 is the same as the configuration as the robot 1 illustrated in FIG. 1.

When the grinder 211 is mounted on the end effector 20, grinding work can be performed on the target object transported by the transport device 50 by the grinder 211. In the example illustrated in FIG. 14, the robot 1 performs grinding work on an edge H₄ (an edge imaged by the camera 30) of a rectangular parallelepiped target object W₄ by the grinder 211.

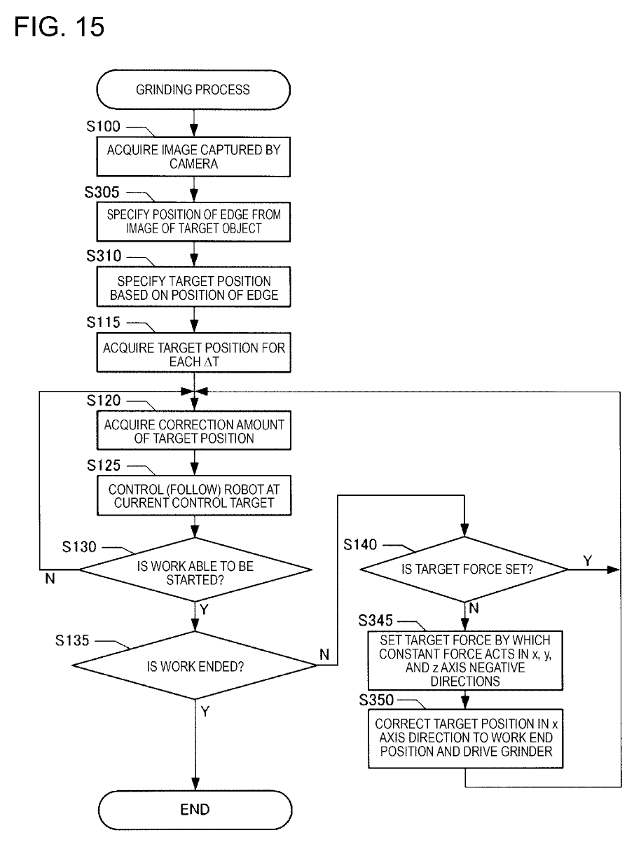

FIG. 15 is a flowchart illustrating an example of the grinding process performed by the grinding work illustrated in FIG. 14. The grinding process is performed when transport of the target object W₄ by the transport device 50 is started. The flowchart of FIG. 15 is substantially the same as the flowchart of FIG. 7 except for steps S305, S310, S345, and S350. Since the process of FIG. 15 can be understood by replacing the “screw fastening work” as “grinding work”, replacing the “screw hole” as the “edge”, and replacing the “screw driver 21” as the “grinder 211” in the process of FIG. 7, respectively, hereinafter, contents of steps S345 and S350 will mainly be described.

When it is determined in step S140 of FIG. 15 that the target force is not set, the robot control device 40 sets a target force by which a constant force acts on the grindstone of the grinder 211 in the x, y, and z axis negative directions by the function of the force control instruction acquisition unit 42a (step S345). That is, the constant force acts on the grinder 211 in the x axis negative direction and the target force f_{St} to act on the TCP is set so that the grinding is performed while pressing the grindstone of the grinder 211 in the direction of the target object W₄ by a resultant force of a force in the y axis negative direction and a force in the z axis negative direction.

As a result, the force control unit 42 enters a state in which the correction amount ΔS specified based on the impedance control can be output. Accordingly, when step S125 is performed in this state, the force control in which the force acting on the TCP is set to the target force f_{St} is performed. By this force control, the grinder 211 is smoothly moved along the edge H₄ of the target object W₄ and the grinding can be performed in a state in which the grindstone is tightly pressed against a grinding target.

Subsequently, the robot control device 40 corrects the target position in the x axis direction to a work end position and drives the grinder 211 (step S350). That is, the robot control device 40 specifies a position at the time of completing the grinding based on a command by the function of the target position acquisition unit 41b and corrects the target position in the x axis direction to this position. Since a target position in the y axis direction is corrected over time with the correction amount Sₜₘ corresponding to the movement amount of the target object W₄ in step S120, the target position is set in step S125 after the correction of step S350 so that the grinder 211 follows the target object W₄ in the y axis direction and the grinder 211 is moved in the direction of the edge in the x axis direction. Further, in step S350, the robot control device 40 outputs a control signal to the grinder 211 and starts rotating the grinder 211 by the function of the instruction integration unit 43.

When step S350 is performed and subsequently steps S120 to S140 are repeated, the robot control device 40 causes the instruction integration unit 43 to move the robot 1 in the x axis negative direction while moving the robot 1 in the y axis direction in step S125. Then, in a state in which the grindstone of the grinder 211 comes into contact with the edge H₄, control is performed such that a constant force acts in the x axis negative direction and the grindstone is tightly pressed against the edge H₄ by a resultant force of a force in the y axis negative direction and a force in the z axis negative direction. Therefore, the grinding can be performed without disturbing the movement of the target object W₄ which is being moved.

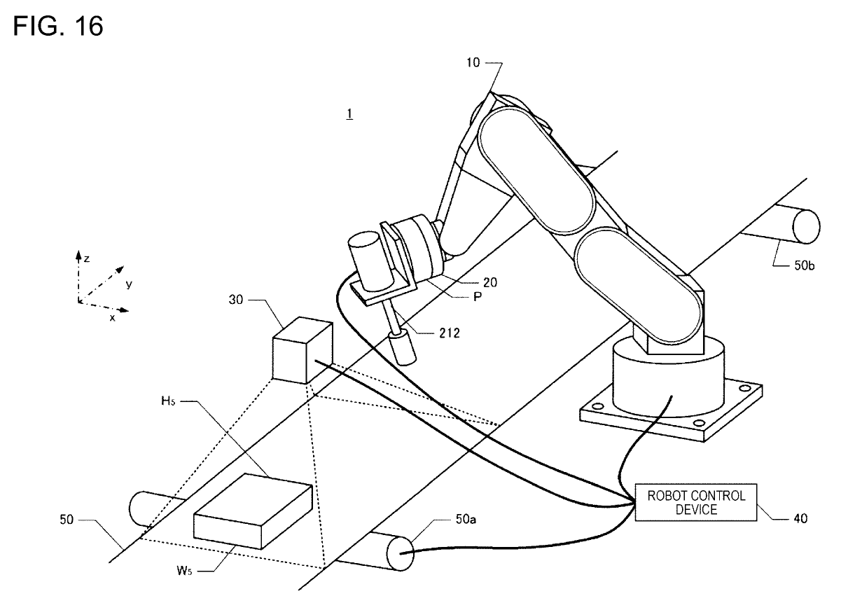

FIG. 16 illustrates a robot system performing deburring work, and illustrates a configuration in which a deburring tool 212 is mounted on the end effector 20 of the robot 1 illustrated in FIG. 1. In the configuration illustrated in FIG. 16, a configuration other than the deburring tool 212 is the same as the configuration of the robot 1 illustrated in FIG. 1.

When the deburring tool 212 is mounted on the end effector 20, deburring work can be performed on the target object transported by the transport device 50 by the deburring tool 212. In the example illustrated in FIG. 16, the robot 1 performs the deburring work on an edge H₅ (an edge imaged by the camera 30) of a rectangular parallelepiped target object W₅ by the deburring tool 212.

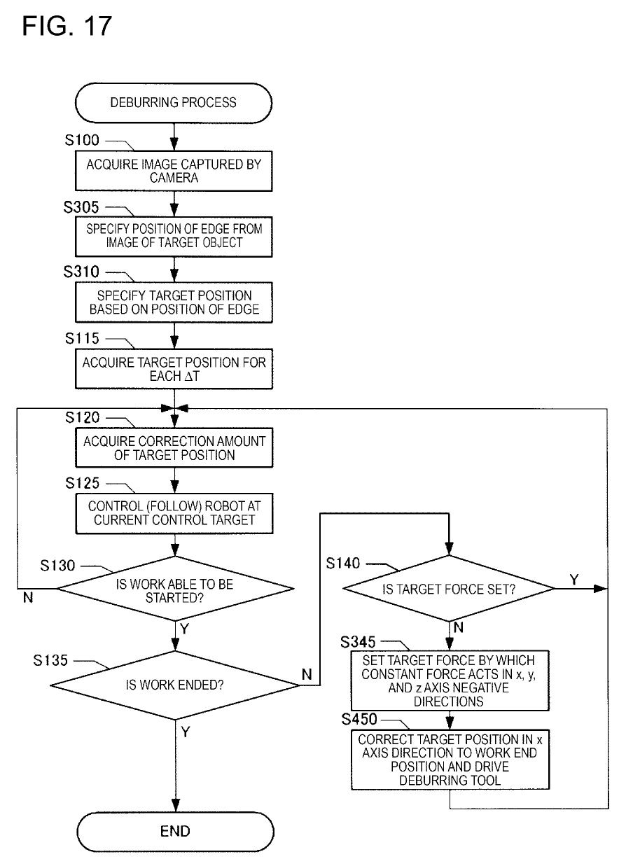

FIG. 17 is a flowchart illustrating an example of the deburring process for performing the deburring work illustrated in FIG. 16. The deburring process is performed when transport of the target object W₅ by the transport device 50 is started. The flowchart of FIG. 17 is substantially the same as the flowchart of FIG. 15 except for step S450. Since the process of FIG. 17 can be understood by replacing the “grinding work” as “deburring work” and replacing the “grinder 211” as the “deburring tool 212” in the process of FIG. 15, respectively, hereinafter, contents of step S450 will mainly be described.

When a target force by which a constant force acts on the deburring unit of the deburring tool 212 in the x, y, and z axis negative directions is set in step S345, the robot control device 40 corrects the target position in the x axis direction to a work end position and drives the deburring tool 212 (step S450). That is, the robot control device 40 specifies a position at the time of completing the deburring based on a command by the function of the target position acquisition unit 41b and corrects the target position in the x axis direction to this position. Since a target position in the y axis direction is corrected over time with the correction amount Sₜₘ corresponding to the movement amount of the target object W in step S120, the target position is set in step S125 after the correction of step S450 so that the deburring tool 212 follows the target object W₅ in the y axis direction and the deburring tool 212 is moved in the direction of the edge in the x axis direction. Further, in step S450, the robot control device 40 outputs a control signal to the deburring tool 212 and starts rotating the deburring tool 212 by the function of the instruction integration unit 43.

When step S450 is performed and subsequently steps S120 to S140 are repeated, the robot control device 40 causes the instruction integration unit 43 to move the robot 1 in the x axis negative direction while moving the robot 1 in the y axis direction in step S125. Then, in a state in which the deburring unit of the deburring tool 212 comes into contact with the edge H₅, control is performed such that a constant force acts in the x axis negative direction and the deburring unit is tightly pressed against the edge H₅ by a resultant force of a force in the y axis negative direction and a force in the z axis negative direction. Therefore, the deburring can be performed without disturbing the movement of the target object W₅ which is being moved.

The entire disclosures of Japanese Patent Application Nos. 2016-220245 filed on Nov. 11, 2016 and No. 2017-189820 filed on Sep. 29, 2017 are expressly incorporated by reference herein.

1.-14. (canceled)

15. A robot control device that performs, during movement of an end effector of a robot in a movement direction of a target object, force control by which a force acts on the target object based on an output of a force detection unit included in the robot to cause the robot to perform work on the target object by the end effector,
wherein whether the work is able to be started is determined in a process where the end effector follows the movement of the target object, and
when it is determined that the work is able to be started, the work is caused to start.

16. The robot control device according to claim 15,
wherein when the robot is caused to perform the work, a control target position is obtained by adding a first position correction amount representing a movement amount of the target object and a second position correction amount calculated by the force control to a target position when assuming that the target object is stopped and feedback control using the control target position is executed.

17. The robot control device according to claim 16,
wherein a representative correction amount determined from a history of the second position correction amount is acquired and the representative correction amount is added to the first position correction amount relating to a new target object when the end effector is caused to follow the new target object.

18. The robot control device according to claim 16, comprising:
a position control unit that obtains the target position and the first position correction amount;
a force control unit that obtains the second position correction amount; and
an instruction integration unit that obtains the control target position by adding the first position correction amount and the second position correction amount to the target position and executes feedback control using the control target position.

19. The robot control device according to claim 16, further comprising:
a processor configured to execute a computer executable instruction to control the robot,
wherein the processor is configured to obtain the target position, the first position correction amount, and the second position correction amount, obtain the control target position by adding the first position correction amount and the second position correction amount to the target position, and execute feedback control using the control target position.

20. The robot control device according to claim 15,
wherein the end effector follows the target object and is caused to move in a direction parallel to the movement direction of the target object, and
in order for the robot to perform the force control, the end effector is caused to move in a direction perpendicular to the movement direction of the target object.

21. The robot control device according to claim 15,
wherein a screw driver included in the end effector is caused to perform work of screw fastening on the target object.

22. The robot control device according to claim 15,
wherein work of fitting a fitting object gripped by a gripping unit included in the end effector into a fitting portion formed on the target object is caused to be performed.

23. The robot control device according claim 15,
wherein a grinding tool included in the end effector is caused to perform work of grinding the target object.

24. The robot control device according to claim 15,
wherein a deburring tool included in the end effector is caused to perform work of deburring the target object.

25. A robot controlled by the robot control device according to claim 15.

26. A robot system comprising:
the robot control device according to claim 15; and
the robot that is controlled by the robot control device.

27. A robot control method comprising:
during movement of an end effector of a robot in a movement direction of a target object,
performing force control by which a force acts on the target object based on an output of a force detection unit included in the robot to cause the robot to perform work on the target object by the end effector;
determining whether the work is able to be started in a process where the end effector follows the movement of the target object; and
causing the work to start when it is determined that the work is able to be started.

28. The robot control device according to claim 16,
wherein the end effector follows the target object and is caused to move in a direction parallel to the movement direction of the target object, and
in order for the robot to perform the force control, the end effector is caused to move in a direction perpendicular to the movement direction of the target object.

29. The robot control device according to claim 16,
wherein a screw driver included in the end effector is caused to perform work of screw fastening on the target object.

30. The robot control device according to claim 16,
wherein work of fitting a fitting object gripped by a gripping unit included in the end effector into a fitting portion formed on the target object is caused to be performed.

31. The robot control device according to claim 16,
wherein a grinding tool included in the end effector is caused to perform work of grinding the target object.

32. The robot control device according to claim 16,
wherein a deburring tool included in the end effector is caused to perform work of deburring the target object.
